(19) United States
(12) Patent Application Publication
(10) Pub. No.: US 2014/0044197 A1
(43) Pub. Date: Feb. 13, 2014

(54) METHOD AND SYSTEM FOR CONTENT-AWARE MULTIMEDIA STREAMING

(71) Applicants: Yiting Liao, Hillsboro, OR (US); Jeffrey R. Foerster, Portland, OR (US)

(72) Inventors: Yiting Liao, Hillsboro, OR (US); Jeffrey R. Foerster, Portland, OR (US)

(21) Appl. No.: 13/571,479

(22) Filed: Aug. 10, 2012

(51) Int. Cl. H04N 7/26

(52) U.S. Cl. 375/240.26; 375/E07.2

(57) ABSTRACT

A system and method for classifying video content into a plurality of video content categories; and adaptively generating video encoding profiles for the video content based on, at least, the plurality of video content categories.

### BACKGROUND

The streaming of multimedia over networks continues to grow at a tremendous rate. In some aspects, the continued growth of multimedia streaming may be attributed to its increasing presence and/or importance in new media and entertainment applications, as well as gains in its use in educational, business, travel, and other contexts. In some instances, the networks used for streaming multimedia may be wired or wireless and may include the Internet, television broadcast, satellite, cellular, and WiFi networks. Important to a video experience is the quality of video received for viewing by a user. In some aspects, increasing service capacity and enhancing end-user quality of experience (QoE) may be facilitated by different optimization techniques.

A number of adaptive video streaming techniques have been proposed in an effort to increase service capacity and enhance end-user QoE. Some such techniques address streaming capacity and quality problems by encoding a video source into short segments at different pre-determined bitrates. The encoded short segments of video are then delivered over a network based on the available network bandwidth and processing conditions.

While techniques considering available network bandwidth and processing conditions may or may not address some broad video quality issues to an extent, such techniques are not typically adaptive to, responsive to, or even aware of the variety of the types of video transmitted.

### BRIEF DESCRIPTION OF THE DRAWINGS

Aspects of the present disclosure herein are illustrated by way of example and not by way of limitation in the accompanying figures. For purposes related to simplicity and clarity of illustration rather than limitation, aspects illustrated in the figures are not necessarily drawn to scale. Further, where considered appropriate, reference labels have been repeated among the figures to indicate corresponding or analogous elements.

FIG. 1 is an illustrative graph related to some aspects of video herein.

FIG. 2 is a flow diagram of a process, in accordance with one embodiment herein.

FIG. 3 is another flow diagram of a process, in accordance with some embodiments herein.

FIG. 4 is a functional block diagram of a system, in accordance with an embodiment.

FIGS. 5A-5D are illustrative depictions of video scenes, in accordance with some embodiments herein.

FIG. 6 is an illustrative schematic block diagram of a system according to some embodiments herein.

### DETAILED DESCRIPTION

The following description describes a method and system that may support processes and operations to improve a quality and an efficiency of a video transmission by providing a content-aware video adaption technique. As will be explained in greater detail below, the present disclosure herein provides some embodiments of a technique or mechanism that adaptively selects coding parameters and allocates resources based on the content of a video sequence being encoded for transmission over a network. The technique(s) disclosed herein may, in some embodiments, operate to minimize bitrate consumption and/or improve the quality of the encoded video transmitted over the network.

In some regards, the present disclosure includes specific details regarding method(s) and system(s) for implementing the processes and systems herein. However, it will be appreciated by one skilled in the art(s) related hereto that embodiments of the present disclosure may be practiced without such specific details. Thus, in some instances aspects such as control mechanisms and full software instruction sequences have not been shown in detail in order not to obscure other aspects of the present disclosure. Those of ordinary skill in the art will be able to implement appropriate functionality without undue experimentation given the included descriptions herein.

References in the present disclosure to “one embodiment”, “some embodiments”, “an embodiment”, “an example embodiment”, “an instance”, “some instances” indicate that the embodiment described may include a particular feature, structure, or characteristic, but that every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Some embodiments herein may be implemented in hardware, firmware, software, or any combinations thereof. Embodiments may also be implemented as executable instructions stored on a machine-readable medium that may be read and executed by one or more processors. A machine-readable storage medium may include any tangible non-transitory mechanism for storing information in a form readable by a machine (e.g., a computing device). In some aspects, a machine-readable storage medium may include read only memory (ROM); random access memory (RAM); magnetic disk storage media; optical storage media; flash memory devices; and electrical and optical forms of signals. While firmware, software, routines, and instructions may be described herein as performing certain actions, it should be appreciated that such descriptions are merely for convenience and that such actions are in fact result from computing devices, processors, controllers, and other devices executing the firmware, software, routines, and instructions.

FIG. 1 is an illustrative graph 100 depicting observed rate-quality characteristics for a variety of video content under different coding settings. The content characteristics of the video reflected in graph 100 varies. For example, some of the video content may include very little motion (e.g., a newscast of anchors seated at a desk) and some of the video content may include a high amount of motion (e.g., a sporting event with numerous players moving about a field of play simultaneously). The coding settings may include, for example, frame structure, GOP (group of pictures) size, etc. Regarding graph 100, horizontal axis 105 denotes a bitrate scale and vertical axis 110 represents a video quality metric (i.e., the Multi-Scale Structural SIMilarity (MS-SSIM) index) scale. Graph 100 illustrates the point that video quality may vary over a large range for video encoded at the same bitrate. For example, at the 4 Mbps rate, the mean MS-SSIM value varies from about 0.87 to about 0.98 for different videos encoded at different settings. Also, graph 100 demonstrates, for example, that for a video quality of 0.95 MS-SSIM the required bitrate may vary from about 2 Mbps to about 14 Mbps.

Accordingly, graph 100 demonstrates that a video encoding and transmission method that uses fixed (en)coding parameter(s) for all video content may result in either a waste of bandwidth or a degradation in video quality.

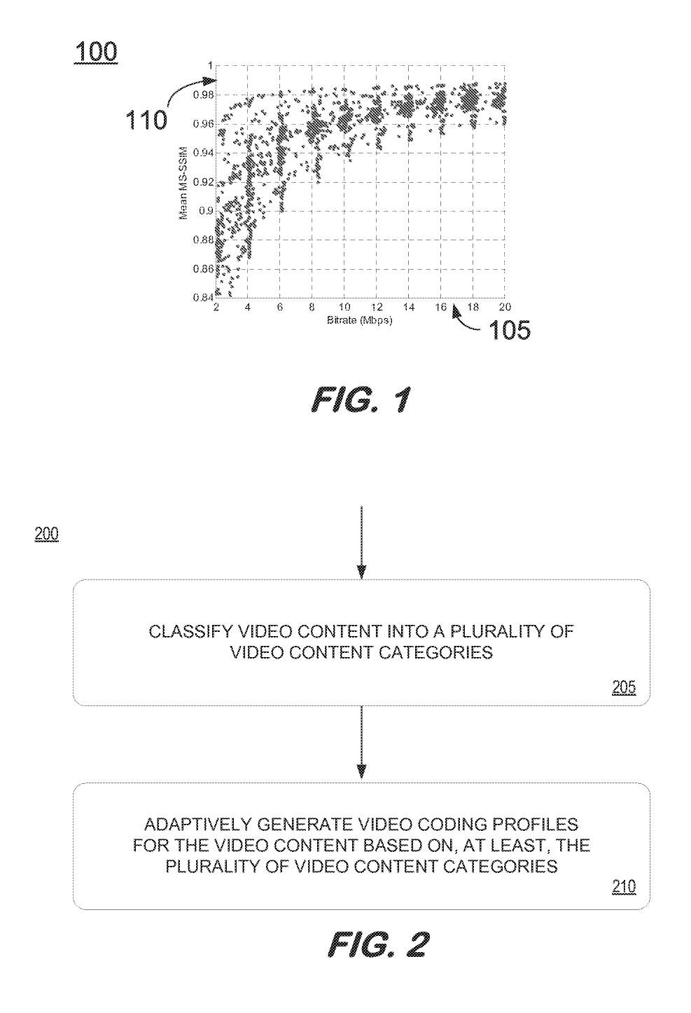

FIG. 2 is an illustrative flow diagram of a process 200, in accordance with an embodiment herein. Process 200 may account for the large variance of rate-quality performance that may result from different video content by determining an optimized, or at least more efficient, coding profile that minimizes bitrate consumption while also satisfying user QoE standards.

At operation 205, incoming video content may be classified into a variety of video content categories. The video received at operation 205 may come from any source, including live feeds and being retrieved from a storage location. The video received at operation 205 may be classified based on one or more characteristics of the video itself (i.e., the content of the video). In some embodiments, a motion intensity characteristic of the received video may be evaluated and the video may be categorized into one of three categories—low motion, intermediate motion, or high motion.

At operation 210, one or more video coding profiles may be adaptively generated for the video content based on, at least, the plurality of video content categories determined at operation 205. As illustrated in FIG. 2, operation 210 may receive an indication of the video content categories from operation 205. In some aspects (as discussed in greater detail below), operation 210 may receive additional information as inputs in addition to the video content categories information from operation 205. The video content categories from operation 205 and other information may be used by operation 210 to adaptively generate coding profiles for the different categories of video content. It is noted that the different categories of video content may each relate to or be associated with a different type of video content (i.e., video having different characteristics).

The coding profiles adaptively generated at operation 210 based at least on the determined plurality of video content categories may be stored or output in a record or file, used as an input for further processing and transmission of the video content, and for other processes.

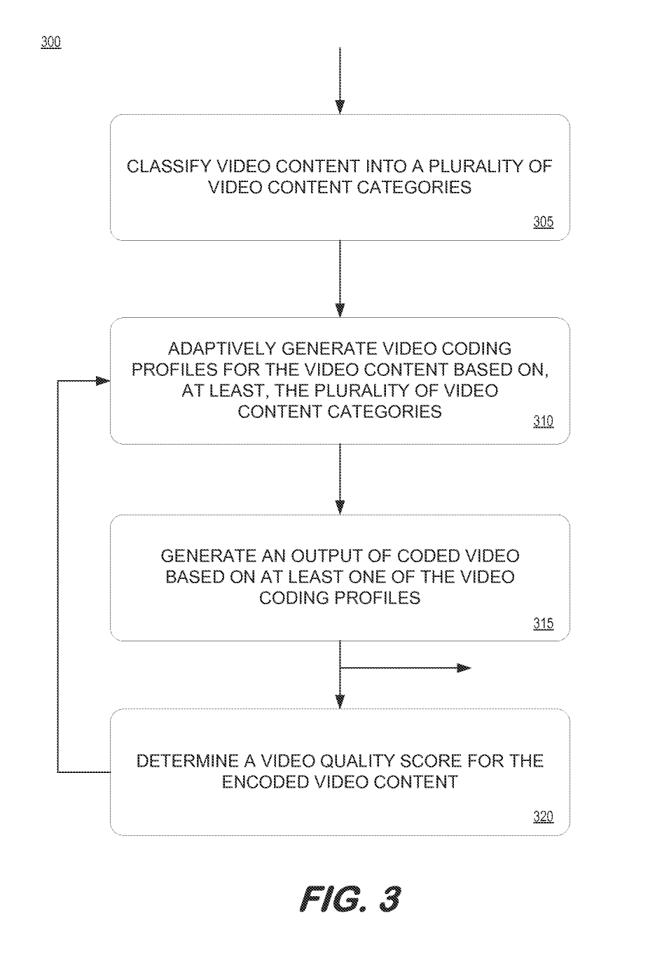

FIG. 3 relates to a process 300, in accordance with some embodiments herein. In some aspects, process 300 is similar to process 200 of FIG. 2. For example, operations 305 and 310 may correspond to operations 205 and 210, respectively. Accordingly, a detailed discussion of operations 305 and 310 is not provided herein since a full understanding of those operations may be had by referring to the discussion of operations 205 and 210 hereinabove.

Referring to FIG. 3, operation 315 generates an output of (en)coded video based on at least one of the video coding profiles adaptively generated at operation 310. An output of operation 315 may be used to determine or calculate a video quality score or measure for the encoded video at operation 320. The video quality score determined at operation 320 may provide an indication of the quality of the encoded video. In some aspects, the video quality score may comprise a video quality assessment (VQA) metric calculated in accordance with one or more VQA algorithms.

As further illustrated in FIG. 3, the video quality score determined at operation 320 may be passed to operation 310 so that the coding parameters used at operation 310 to generate the coding profiles may be recursively adjusted in order to adaptively generate coding profiles based on, in part, the video content categories and the quality of the encoded video content.

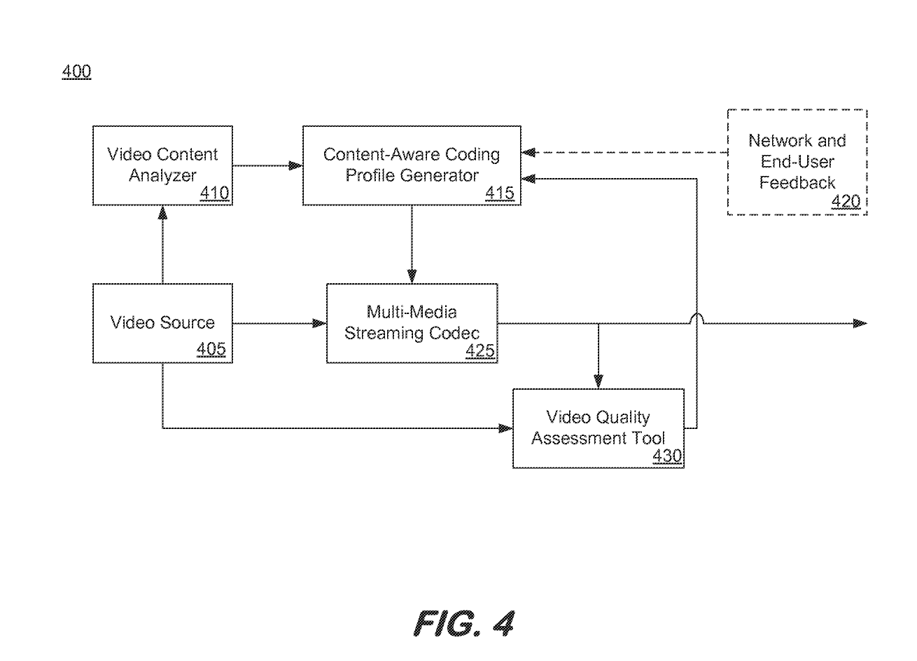

FIG. 4 is an illustrative depiction of a functional block diagram of an apparatus or device 400, according to some embodiments herein. In some aspects, device 400 may include a content-aware multimedia streaming server to implement some portions of processes disclosed herein (e.g., processes 200 and 300). In some embodiments, device 400 may be implemented in hardware, software, and combinations thereof. In some aspects, device 400 may include fewer, greater, analogous, or alternative functional components than those specifically shown in FIG. 4. In some embodiments, the functional blocks shown in FIG. 4 may be implemented in one or more components, as well as being combined with other functions and/or components.

Video content is provided by or received from video source 405. Video source 405 may be any type of mechanism for providing the video content, including a live or re-broadcast data stream and a file or record including a video sequence retrieved from a storage facility (i.e., memory). The video content from video source 405 is fed to a video content analyzer 410. Video content analyzer 410 may operate to analyze the content characteristics of the video from video source 405. In some embodiments, video content analyzer 410 may include video feature extraction mechanisms or techniques to identify different characteristics of the content of the video. Video content analyzer 410 may further classify the video content into different categories based on the categorized video content (e.g., operations 205 and 305).

An indication of the different video categories associated with the video content analyzed by video content analyzer 410 is provided to a content-aware coding profile generator 415. Content-aware coding profile generator 415 may gather information from multiple sources to adaptively generate optimized coding profiles for different types of video content. In some embodiments, the different types of video content corresponds to the different categories of the video content. In some aspects, the input information to content-aware coding profile generator 415 may include, at least, the video content categories from video content analyzer 410. Additional input information to content-aware coding profile generator 415 may include, for example, video quality scores calculated at the server 400 by a video quality assessment tool 430 and network condition and other user requirement feedback 420.

Coding profile generator 415 may operate to generate one or more content-optimized coding profiles by adaptively selecting a target bitrate, an encoding resolution, an encoding frame rate, a rate control algorithm, a frame structure, a group of picture (GOP) size, a number of a specific type of frame (e.g., bi-directional of “B” frames), and other coding parameters, alone and in combinations thereof. It will be appreciated that the present disclosure encompasses these and other coding parameters, whether specifically enumerated herein.

Coding profile generator 415 may provide the one or more content-optimized coding profiles generated thereby to a multimedia streaming codec 425. Codec 425 may use the content-optimized coding profiles to encode the video content from video source 405 with the appropriate coding profiles generated by video coding profile generator 415. The appropriate coding profile(s) may optimally match the type of content in the video.

The encoded video output by codec 425 is provided, in part, to video quality assessment (VQA) tool 430. VQA tool 430 may calculate video quality or VQA score(s) for the encoded video. The VQA score(s) may be passed to content-aware coding profile generator 415. Upon receipt of the VQA scores, content-aware coding profile generator 415 may recursively adjust the coding parameters used therein and generate optimized coding profiles based on, at least, the video content and the VQA scores.

In some embodiments, reference-based VQA metrics such as MS-SSIM may be used since the video source is available at the server side.

Applicant has realized the effectiveness of the processes disclosed herein by determining a bitrate minimization using the content-aware video adaption processes disclosed herein and comparing them to baseline coding schemes that use a fixed coding profile for all video sequences. The video sequences used in the evaluation and the following tables include the publically available “Aspen”, “ControlledBurn”, “RedKayak”, “SpeedBag”, “TouchdownPass”, and “WestWindEasy” video sequences under different bitrates.

Table 1 below shows the gains observed for the content-aware video adaptation method(s) herein compared to baseline schemes in which a fixed coding profile is applied to all of the input video sequences. In the example of Table 1, it is assumed that users are satisfied when an average PSNR (Peak Signal to Noise Ratio) that is greater than 34 dB. The baseline schemes relating to Table 1 use fixed quantization parameters (QPs) to encode the video sequences while the content-aware (i.e., optimized) method adaptively selects the coding parameters based on the different types of video content characteristics detected in the input video sequence. As seen, the results listed in the Table 1 show that in order to satisfy users for all video sequences, an average bitrate saving of 3.55 Mbps is achieved using the content-aware video adaptation process disclosed herein.

TABLE 1

| | Baseline (QP = 34) | | Baseline (QP = 32) | | Optimized | |
|---|---|---|---|---|---|---|
| | | Avg. | | Avg. | | Avg. |
| | Bitrate | PSNR | Bitrate | PSNR | Bitrate | PSNR |
| Sequence | (Mbps) | (dB) | (Mbps) | (dB) | (Mbps) | (dB) |
| Aspen | 7.94 | 34.74 | 10.03 | 35.80 | 4.89 | 34.17 |
| Controlledburn | 6.45 | 33.65 | 8.07 | 34.75 | 4.90 | 34.03 |
| Redkayak | 8.01 | 34.00 | 10.14 | 35.14 | 7.65 | 34.11 |
| Speedbag | 6.44 | 39.02 | 7.58 | 39.81 | 2.12 | 35.62 |
| Touchdownpass | 4.02 | 36.04 | 5.01 | 36.76 | 2.18 | 34.02 |
| Westwindeasy | 7.26 | 33.56 | 9.12 | 34.77 | 6.92 | 34.26 |
| Bitrate/User | 6.69 | 66.7% | 8.32 | 100% | 4.77 | 100% |
| Satisfaction | | | | | | |

Table 2 below provides, as an example, a listing of the coding parameter settings for each video sequence of Table 1.

TABLE 2

| | | | Number of B |
|---|---|---|---|
| Sequence | Rate Control | GOP Size | Frames |
| Aspen | VBR = 5 Mbps | 30 | 2 |
| Controlledburn | QP = 32, ΔP/ΔB = 2 | 15 | 2 |
| Redkayak | QP = 32, ΔP/ΔB = 2 | 15 | 0 |
| Speedbag | CBR = 2 Mbps | 30 | 0 |
| Touchdownpass | QP = 38, ΔP/ΔB = 2 | 30 | 0 |
| Westwindeasy | QP = 30, ΔP/ΔB = 2 | 30 | 2 |

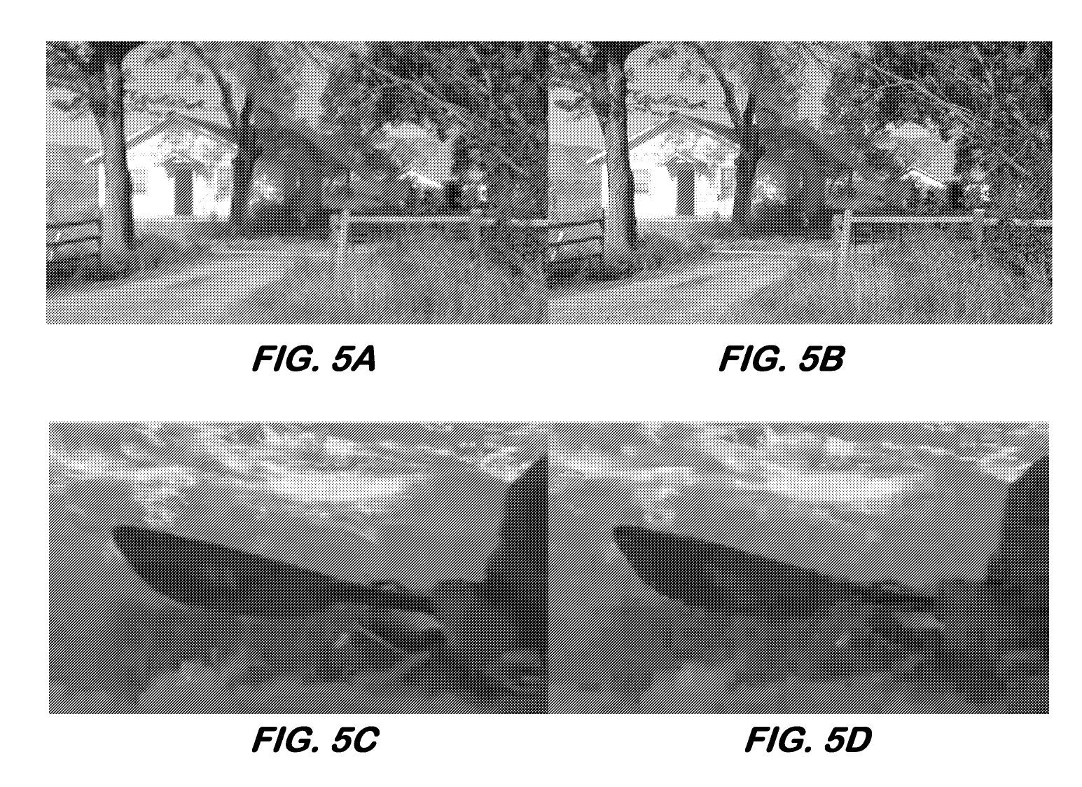

FIGS. 5A-5D pictorially illustrate examples of how the processes of adapting encoding resolutions to video content disclosed herein may improve the video quality of a video sequence. The video sequences “Controlledburn” (FIGS. 5A and 5B) and “Redkayak” (FIGS. 5C and 5D) are shown encoded at a 220×124 resolution (FIGS. 5A and 5C) and a 768×432 resolution (FIGS. 5B and 5D), respectively. It is noted that both of the video sequences are encoded at the same bitrate (i.e., 230 kbps). For the “Controlledburn” video sequence, encoding at a higher resolution as shown in FIG. 5B reduces the blurriness of the video and improves the perceptual video quality. However, encoding the “Redkayak” video sequence at the higher resolution results in the video looking very blocky and degrades the video quality, as shown in FIG. 5D. Accordingly, it is demonstrated that adapting coding parameters (e.g., encoding resolution, etc.) to the specific type(s) of video content of a video sequence (i.e., video characteristics) may effectively enhance the QoE of a video streaming service, application, system, process, or device.

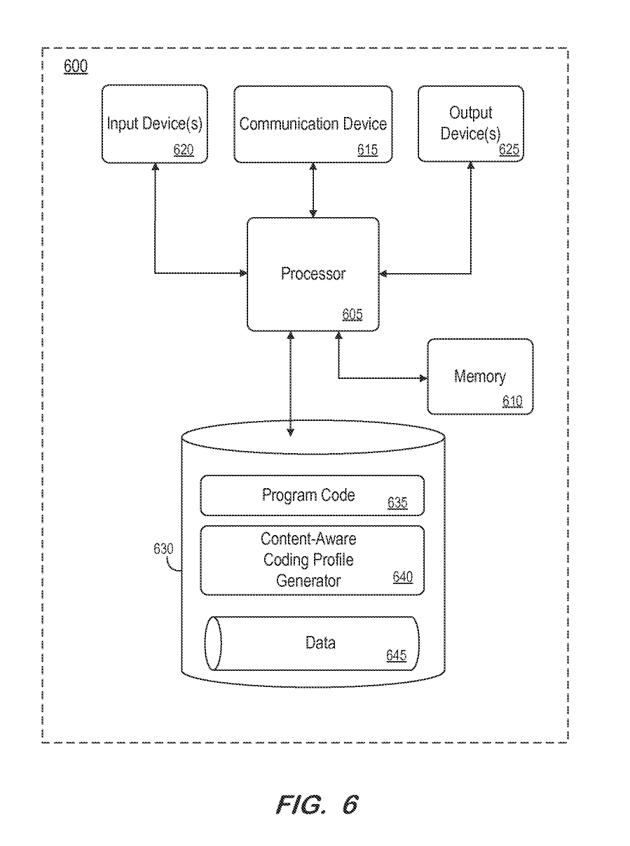

FIG. 6 is a block diagram overview of a system or apparatus 600 according to some embodiments. System 600 may be, for example, associated with any device to implement the methods and processes described herein, including for example a server (e.g., FIG. 4, device 400) of a streaming service provider that provisions multimedia data or any other entity. System 600 comprises a processor 605, such as, for example, one or more commercially available Central Processing Units (CPUs) in the form of one-chip microprocessors or a multi-core processor, coupled to a communication device 615 configured to communicate via a communication network (not shown in FIG. 6) to another device or system. In the instance system 600 comprises an application server, communication device 615 may provide a means for system 600 to interface with a client device. System 600 may also include a local memory 610, such as RAM memory modules. The system 600 further includes an input device 620 (e.g., a touch screen, mouse and/or keyboard to enter content) and an output device 625 (e.g., a computer or other device monitor/screen to display a user interface).

Processor 605 communicates with a storage device 630. Storage device 630 may comprise any appropriate information storage device, including combinations of magnetic storage devices (e.g., a hard disk drive), optical storage devices, and/or semiconductor of solid state memory devices. In some embodiments, storage device may comprise a database system.

Storage device 630 stores a program code 635 that may provide computer executable instructions for processing requests from, for example, client devices in accordance with processes herein. Processor 605 may perform the instructions of the program 635 to thereby operate in accordance with any of the embodiments described herein. Program code 635 may be stored in a compressed, uncompiled and/or encrypted format. Program code 635 may furthermore include other program elements, such as an operating system, a database management system, and/or device drivers used by the processor 605 to interface with, for example, peripheral devices. Storage device 630 may also include data 645 such as a video sequence and/or user preferences or settings. Data 645, in conjunction with context-aware coding profile generator 640, may be used by system 600, in some aspects, in performing the processes herein, such as processes 200 and 300.

All systems and processes discussed herein may be embodied in program code stored on one or more computer-readable media. Such media may include, for example, a floppy disk, a CD-ROM, a DVD-ROM, one or more types of “discs”, magnetic tape, a memory card, a flash drive, a solid state drive, and solid state Random Access Memory (RAM), Read Only Memory (ROM) storage units, and other non-transitory media. Furthermore, the systems and apparatuses disclosed or referenced herein may comprise hardware, software, and firmware, including general purpose, dedicated, and distributed computing devices, processors, processing cores, and microprocessors. In some aspects, the processes and methods disclosed herein may be delivered and provided as a service. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method comprising:
classifying video content into a plurality of video content categories; and
adaptively generating video encoding profiles for the video content based on, at least, the plurality of video content categories.

2. The method of claim 1, further comprising generating an output of encoded video based on at least one of the video coding profiles.

3. The method of claim 2, further comprising:
determining a video quality for the generated encoded video output; and
adaptively generating the video profiles based on the determined video quality.

4. The method of claim 1, further comprising identifying at least one video characteristic of the video content and basing the classifying of the video content on the at least one video characteristic.

5. The method of claim 1, wherein the plurality of video content categories includes at least two categories that represent different quantities of motion in the video content.

6. The method of claim 1, wherein the adaptively generating of the video encoding profiles for the video content is further based on, at least one of, a video quality score, an indication of a network condition, a user preference, and combinations thereof.

7. The method of claim 1, wherein the adaptively generated video encoding profiles for the video content establish values for at least one of the following parameters: a target bitrate, an encoding resolution, an encoding frame rate, a rate control algorithm, a frame structure, a group of picture size, and a number of a particular frame type.

8. A system comprising:
a video content analyzer to classify video content into a plurality of video content categories; and
a content-aware coding profile generator to adaptively generate video coding profiles for the video content based on, at least, the plurality of video content categories.

9. The system of claim 8, further comprising a video quality assessment module to generate an output of coded video based on at least one of the video coding profiles.

10. The system of claim 9, wherein the video quality assessment module further determines a video quality for the generated coded video output; and the content-aware coding profile generator adaptively generates the video profiles based on the determined video quality.

11. The system of claim 8, wherein the video content analyzer further identifies at least one video characteristic of the video content and the content-aware coding profile generator bases the classifying of the video content on the at least one video characteristic.

12. The system of claim 8, wherein the plurality of video content categories includes at least two categories that represent different quantities of motion in the video content.

13. The system of claim 8, wherein the content-aware coding profile generator further adaptively generates the video encoding profiles for the video content based on, at least one of, a video quality score, an indication of a network condition, a user preference, and combinations thereof.

14. The system of claim 8, wherein the adaptively generated video encoding profiles for the video content establish values for at least one of the following parameters: a target bitrate, an encoding resolution, an encoding frame rate, a rate control algorithm, a frame structure, a group of picture size, and a number of a particular frame type.

15. A non-transitory medium having processor-executable instructions stored thereon, the medium comprising:
instructions to classify video content into a plurality of video content categories; and
instructions to adaptively generate video encoding profiles for the video content based on, at least, the plurality of video content categories.

16. The medium of claim 15, further comprising instructions to generate an output of encoded video based on at least one of the video coding profiles.

17. The medium of claim 16, further comprising:
instructions to determine a video quality for the generated encoded video output; and
instructions to adaptively generate the video profiles based on the determined video quality.

18. The medium of claim 15, further comprising instructions to identify at least one video characteristic of the video content and basing the classifying of the video content on the at least one video characteristic.

19. The medium of claim 15, wherein the plurality of video content categories includes at least two categories that represent different quantities of motion in the video content.

20. The medium of claim 15, wherein the adaptively generating of the video encoding profiles for the video content is further based on, at least one of, a video quality score, an indication of a network condition, a user preference, and combinations thereof.

21. The medium of claim 15, wherein the adaptively generated video encoding profiles for the video content establish values for at least one of the following parameters: a target bitrate, an encoding resolution, an encoding frame rate, a rate control algorithm, a frame structure, a group of picture size, and a number of a particular frame type.
